(19) United States
(12) Patent Application Publication
(10) Pub. No.: US 2009/0293015 A1
(43) Pub. Date: Nov. 26, 2009

(54) Application Platform

(75) Inventor: MOTOKI IKEDA, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/434,307

(22) Filed: May 1, 2009

(30) Foreign Application Priority Data
May 22, 2008 (JP) 2008-134546

(51) Int. Cl. G06F 9/00; G06F 9/445; G06F 3/048

(52) U.S. Cl. 715/810; 713/100; 717/174

(57) ABSTRACT

In devices of comparatively small system resources such as a multi function printer, when an application is uninstalled, a user cannot refer to or operate information having been managed by the application that has been uninstalled. With respect to an application, an alternative application to be started as an alternative in the case in which the application is uninstalled is associated. On the occasion when the application is uninstalled, the alternative application is automatically started.

### BACKGROUND OF THE INVENTION

1. Field of the Invention

The present invention relates to an application platform for managing an application.

2. Description of the Related Art

A multi function printer that can install and uninstall an application has been proposed (Japanese Patent Laid-open No. 2002-287990). A multi function printer vendor or a third party vendor in alliance therewith sells a variety of applications for a multi function printer. A user, by purchasing and installing the desired application from among these applications, can match the operation of a multi function printer to individual needs.

To change the operation form of a multi function printer using the above-described conventional technique, a user normally uninstalls the previously used application upon installing a new application. Alternatively, there are some cases in which the application is provided for a trial period that, upon expiration, is uninstalled from the multi function printer. In case the an application is uninstalled, a problem exists in that information having been created and managed by the uninstalled application cannot be accessed, and a user cannot access, reference or print this information.

In this respect, in devices such as a personal computer (PC) or a personal digital assistant (PDA), an uninstall operation due to an update or exchange of an application is executed without the above-discussed problem. The reason, in the case of e.g., a PC, is the presence of software for managing a folder or a file. Thus, even after individual applications have been uninstalled, the file created by the uninstalled application can be accessed. This access, for example, in the case of a PC using Windows (trademark) OS, is implemented by file management software (function) that is referred to as Explorer. With the Explorer software, a user can trace, open, or retrieve the target file in the PC without depending on individual applications. By using Explorer, for example, after a PDF (Portable Document Format) file creation application has been uninstalled from a PC, a user can access a PDF file.

The reason the above-discussed problem occurs in the case of a multi function printer is due to the difference in arrangement between a PC and a multi function printer. The reason is that, in the case of a multi function printer the capacity of means for storing information is considerably smaller than that of a PC and data management software that is independent of individual applications, such as Explorer, is actually difficult to be incorporated.

This reason will be described in more detail. The file management software to be used on a PC has various functions such as displaying a list of files in various forms, retrieving, moving, duplicating and deleting a file, and displaying a file reference history. Software that is so multi-functioned as well as independent of applications will consume a large amount of system resources (storage capacity of information storage means). Thus, in a multi function printer having a small information storage capacity compared to that of a PC, the software dedicated to manage files that is independent of applications cannot be employed. As a result, in a multi function printer, when the file that has been created by a certain application is stored, it is stored depending on this application. That is, the file that was created by a specified application is stored in an area (folder) managed by this application.

More specifically, the case in which a document management application installed on a multi function printer is uninstalled will be described. Here, the document management application is software that provides a document management function by storing a scanned document or a document received from an external information processing device, such as a HDD (Hard Disk Drive) in the multi function printer. Using this document management application, a user can access the document and operate (for example, print or transmit) the document. In the event that the document management application is uninstalled from the multi function printer, the user will not be able to use the application, nor will it be possible to subsequently access any previously scanned documents or externally received documents stored on the HDD of the multi function printer. In case where such situations occur, to access the document information that is stored in the HDD, a user simply has to install again the document management application that was previously uninstalled. The reinstallation is a heavy burden for a user. Furthermore, in some cases, attempts to install the application again is not possible since a user does not know the reinstallation method. In such cases, it is necessary to make an inquiry to a service center or to send out service personnel, thus increasing the problems of the multi function printer vendor.

### SUMMARY OF THE INVENTION

The present invention is an application platform comprising: an uninstall component configured to uninstall an application in the case in which a user interface receives an instruction of uninstall of the application from a user; a starting component configured to start an alternative application that is linked to an application on the occasion when the application is uninstalled by the uninstall component; and, an associating component configured to associate the application with the alternative application before the user interface receives an instruction of uninstall of the application from a user.

Furthermore, the present invention is an application management method, including the steps of: uninstalling an application in the case in which a user interface receives an instruction of uninstall of the application from a user; starting an alternative application associated with an application on the occasion when the application is uninstalled in the uninstalling step; and, associating the application with the alternative application before the user interface receives an instruction of uninstall of the application from a user.

Further, the present invention is a computer program for controlling a computer to execute the above-mentioned method.

According to the present invention, even in the case in which an application is uninstalled in devices having comparatively small system resources such as a multi function printer, access to information that was managed by an uninstalled application can continue to be provided. Thus, it is possible to prevent non-access by a user to information that was managed by an uninstalled application. Furthermore, by associating the application with its alternative application before an uninstall operation, the alternative application can automatically be started after the application has been uninstalled. Thus, by this preliminary associating process, since it is ensured for a user to be able to access information having been under management of this application, the uninstall operation can be executed without anxiety.

Further features of the present invention will become apparent from the following description of exemplary embodiments (with reference to the attached drawings).

### BRIEF DESCRIPTION OF THE DRAWINGS

FIG. 1 is a block diagram illustrating a schematic arrangement of an image forming device;

FIG. 2 is a data arrangement diagram illustrating an example of management information of an application;

FIG. 3 is a flowchart showing a processing procedure at the time of uninstall according to a first exemplary embodiment;

FIG. 4 is a flowchart showing a processing procedure at the time of install according to the first embodiment;

FIG. 5 is a diagram illustrating one example of a screen data;

FIG. 6 is a diagram illustrating one example of a screen data;

FIG. 7 is a diagram illustrating one example of a screen data;

FIG. 8 is a diagram illustrating one example of a screen data;

FIG. 9 is a diagram illustrating one example of a screen data;

FIG. 10 is a flowchart showing a processing procedure at the time of install according to a second exemplary embodiment;

FIG. 11 is a flowchart showing a processing procedure of link processing according to the second embodiment;

FIG. 12 is a flowchart showing a processing procedure at the time of uninstall according to the second embodiment;

FIG. 13 is a flowchart showing a processing procedure of executing an alternative application according to the second embodiment;

FIG. 14 is a flowchart showing a processing procedure at the time of install according to a third exemplary embodiment; and

FIG. 15 is a flowchart showing a processing procedure at the time of uninstall according to the third embodiment.

### DESCRIPTION OF THE EMBODIMENTS

Hereinafter, the best modes for carrying out the present invention will be described while referring to the drawings.

### Embodiment 1

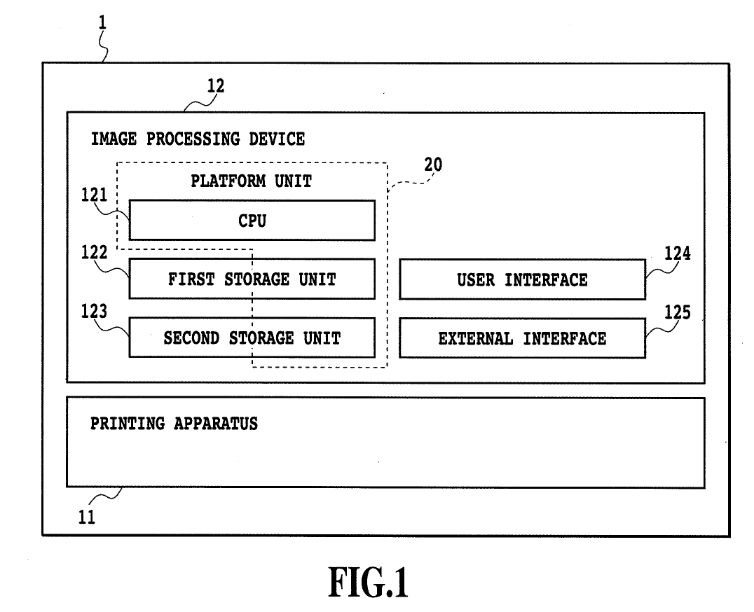

FIG. 1 is a block diagram illustrating a schematic arrangement of an image forming device to which an application platform according to the present invention is applied.

### (Description of Image Forming Device 1)

An image forming device 1 includes a printing apparatus 11 and an image processing device 12.

The image processing device 12 includes a CPU 121, a first storage unit 122 (for example, RAM), a second storage unit 123 (for example, HDD), a user interface 124 and an external interface 125.

The first storage unit 122 directly exchanges data with the CPU 121, and the second storage unit 123 is a indirect storage unit that exchanges data with the CPU 121 via the first storage unit 122. In the first storage unit 122, various application programs and platform programs are stored. A data file created by using a certain application is stored in the second storage unit, and in this case, stored in an area (folder) managed by the application. The below-described alternative application can access the area managed by the uninstalled application.

The user interface 124 includes a keyboard, a mouse, a display and the like. The user interface 124 can receive instructions from a user and display data (screen data).

The external interface 125 can receive data from an external device (not illustrated) or transmit data to the external device. Examples of the external device include, in addition to external storage devices such as an external HDD or an external USB memory, devices separate therefrom such as a separate host computer or image forming device that is connected via network.

### (Description of Platform Unit 20)

The CPU 121 can move (store) a platform program that is stored in the second storage unit 123 to the first storage unit 122. When the storage movement is completed, the CPU 121 is capable of executing the platform program. In this specification, the phrase “the platform unit 20 is started” means “the state in which the CPU 121 can execute a platform program”.

In this embodiment, the platform unit 20 is arranged as follows. The platform unit 20 includes the CPU 121, the area of the first storage unit 122 in which the platform program is stored, and the area of the first storage unit 122 and the second storage unit 123 in which stored is information (operation results and the like) that can be obtained when the CPU 121 processes the above-mentioned platform program.

### (Description of Application Program)

As described above, the CPU 121 of the platform unit 20 moves (transfers) an arbitrary application program stored in the second storage unit 123 to the first storage unit 122. When this transfer is completed, the CPU 121 in the platform unit 20 is capable of executing an arbitrary application program. In this specification, this state is referred to as “the platform unit 20 starts an application program”.

The CPU 121 in the platform unit 20 can also perform processing to delete an arbitrary application program that is stored in the first storage unit 122 from the first storage unit 122. In this specification, it is referred to as “the platform unit 20 stops an application program”.

The platform unit 20 can receive data, being an arbitrary application program from an external device via the external interface unit 125, and can store the received data in the second storage unit 123. In this specification, it is referred to as “an application program is installed on the platform unit 20”.

The CPU 121 in the platform unit 20 can delete an application program that is stored in the second storage unit 123 in the platform unit 20 from the second storage unit 123. In this specification, it is referred to as “the platform unit 20 uninstalls an application program”.

When the platform unit 20 uninstalls an application program from the second storage unit 123 that has been started, the application program is stopped and thereafter uninstalled.

The above descriptions are made in the context of an arbitrary application program. Thus, it will be obvious to those skilled in the art that there is no particular restrictions on an application program here, and that any application that can be used at least in a multi function printer is included in this application program.

### (Description of Management Information of Application)

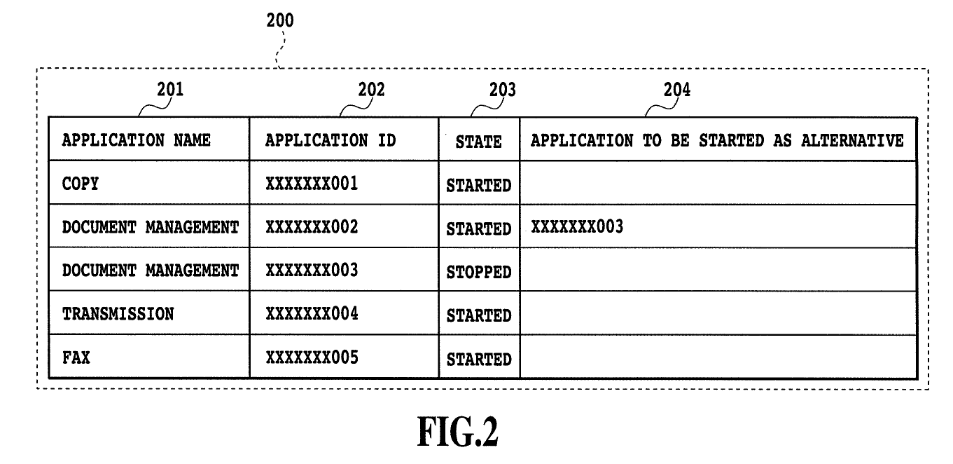

FIG. 2 is a data arrangement diagram illustrating an example of management information of an application.

Application management data 200 is stored and managed in a storage unit in the platform unit 20.

A data item 201 indicates the name of an application.

A data item 202 indicates the ID of an application, and is unique in the application management data 200.

A data item 203 indicates the state of an application. The value of the data item 203 can be either “started” or “stopped”. In the case in which the platform unit 20 has started the application, the data item 203 is “started”. In the case in which the platform unit 20 has stopped the application, the data item 203 is “stopped”.

A data item 204 specifies an alternative application to be started instead of an application to be uninstalled when the platform unit 20 has uninstalled the application of the indicated data item 201. In this embodiment, “xxxxxxx003” is stored as the ID of the alternative application.

One line of the application management data 200 is referred to as a record. The record consists of the data item 201, the data item 202, the data item 203 and the data item 204. The record stands for management information of one application.

The platform unit 20 adds a record to the application management data 200 when installing an application. In the record shortly after addition, the data item 201 and the data item 204 are blank, and the data item 203 is “stopped.” Further, the platform unit 20 generates an ID of a new application, and inputs it at the data item 202 of the added record. This ID is generated so as not to be the same as the data item 202 of the other records of the application management data 200.

The platform unit 20, when having uninstalled an application, deletes its record of the application uninstalled from the application management data 200.

The platform unit 20, in the case of starting or stopping an application, updates the data item 203 so as to be “started” or “stopped”.

The platform unit 20, in the data item 204 of the record of an installed application that can be uninstalled in the future, stores the ID of an alternative application to be started as an alternative when the installed application is uninstalled. Whereby, the application and the alternative application to be started as an alternative when the application is uninstalled are associated.

### (Description of Processing at the Time of Uninstall)

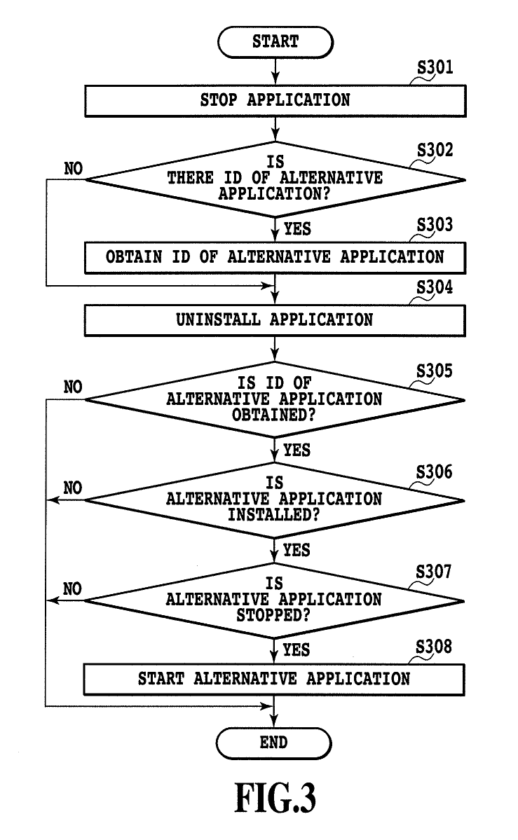

FIG. 3 is a flowchart of showing a processing procedure on the occasion when the platform unit 20 uninstalls an application from the second storage unit 123.

The user interface 124, when having received uninstall instruction of an application from a user, informs the platform unit 20 of this instruction. Whereby, the platform unit 20 executes the following processing.

First, the platform unit 20 stops the application which was instructed to be uninstalled (deletes it from the first storage unit 22) (S301).

Subsequently, the platform unit 20 determines whether or not an alternative application to be started as an alternative is set in this application instructed to be uninstalled (S302). This determination is made by confirming the record of the target application which was instructed to be uninstalled in the application management data 200. In case where the ID of the alternative application is stored in the data item 204 of this record, the alternative application to be started as an alternative is determined to be set. In case where the alternative application to be started as an alternative is determined to be set, processing goes to S303.

In S303, the platform unit 20 obtains the ID of the alternative application to be started instead of the target application which was instructed to be uninstalled, and stores it in the first storage unit 122 in addition to the application management data 200. The ID of the alternative application to be started as an alternative can be obtained by reading out data of the data item 204 that is included in the record of the target application which was instructed to be uninstalled in the application management data 200.

After the processing of S303 is ended, or in the case in which the alternative application is determined not to be set in S302, processing goes to S304. Here, the platform unit 20 uninstalls the target application that was instructed to be uninstalled (S304).

Next, the platform unit 20 determines whether or not the ID of the alternative application is obtained in the processing of S303 (S305). This determination is made by confirming whether or not the ID of this alternative application is stored in the second storage unit 122 in addition to the application management data 200. When the ID of the alternative application is determined to be obtained, processing goes to S306.

Subsequently, the platform unit 20 determines whether or not the application ID of the alternative application indicates that it is installed (S306). This determination is made by searching and confirming the presence or absence of the record in which the name of the application that is coincident with the ID of the alternative application is stored in the data item 201 from each record of the application management data 200. When the alternative application is determined to be installed, processing goes to S307.

In S307, the platform unit 20 determines whether or not the application ID of the alternative application indicates that it is stopped (S307). This determination is made by determining whether or not the value of the data item 203 of the record having the name of the application ID that is coincident with this ID is “stopped”. When the alternative application is determined to be stopped (determined not to be stored in the first storage unit 122), the platform unit 20 starts the application having the ID of the alternative application (stores it in the first storage unit 122) (S308).

On the other hand, in each processing of S305, 306 and S307, as to the alternative application, in the case in which its ID is determined not to be obtained (S305), not to be installed (S306) or not to be stopped (S307), processing is immediately ended.

### (Description of Install Image File)

The external interface 125 receives a file of the below-described form. This file is referred to as an install image file.

The install image file is a file in which an application program of the install target and its name are stored.

In the case in which an application is installed alone, one application program and one name of the application are stored in the install image file.

In the case of installing two applications of an application and an alternative application to be started as an alternative when uninstalling this application, two application programs are stored in the install image file. In addition, in this case, both names of the application to be uninstalled and the alternative application to be started as an alternative are stored in the install image file as well.

### (Description of Processing at the Time of Install)

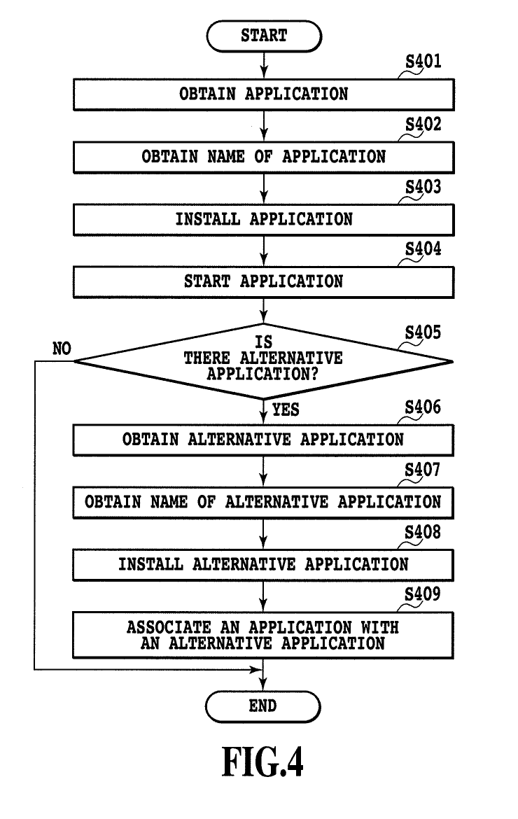

FIG. 4, in this embodiment, is a flowchart showing a processing procedure on the occasion when the platform unit 20 installs an application.

The external interface 125, when having received an install image file, informs the platform unit 20 of this reception. The platform unit 20 then executes the following processing.

First, the platform unit 20 obtains the application program of the install target from the install image file (S401).

Next, the platform unit 20 obtains the name of the application of the install target from the install image file (S402).

Subsequently, the platform unit 20 installs the application program obtained in S401 (S403). On this occasion, the platform unit 20, as described above, adds a record to the application management data 200, and stores the name of the application having been obtained in S402 in the data item 201 of the added record.

Furthermore, the platform unit 20 starts the installed application (S404).

Next, the platform unit 20 determines whether or not in addition to the application obtained in S401, there is stored an alternative application to be started as an alternative when this obtained application is uninstalled (S405). In S405, in the case in which the alternative application is determined to be stored, processing goes to S406. In S405, in the case in which the alternative application is determined not to be stored, processing is ended.

In S406, the platform unit 20 obtains the alternative application program from the install image file.

Next, the platform unit 20 obtains the name of the alternative application from the install image file (S407).

Subsequently, the platform unit 20 installs the alternative application program (S408). On this occasion, as is described above, the platform unit 20 adds a record to the application management data 200, and inputs the name of the alternative application in the data item 201 of the added record.

Finally, the platform unit 20 stores the ID of the alternative application generated in S408 in the data item 204 of the record added in S403. Thus, the application and the alternative application to be started as an alternative when this installed application is uninstalled are associated (S409).

(Description of Example of an Application and an Alternative Application to be Started as an Alternative on the Occasion when this Application is Uninstalled in the Present Invention)

As an example of an application and an alternative application to be started as an alternative when this application is uninstalled that is applicable to the present invention, a document management application and a degraded document management application as described below.

The document management application provides a variety of document management functions to a user.

The platform unit 20 performs the following processing by executing this document management application.

First, processing of controlling the image processing device 12 to read a document, and storing the document having been read in the second storage unit 123 and managing it (document generation processing); second, processing of storing a document having been received from an external device via the external interface 125 in the second storage unit 123 and managing it (document reception processing); third, processing of providing browsing or reference to the document that is stored in the second storage unit 123 via the user interface 124 (document reference processing); fourth, processing of printing the document that is stored in the second storage unit 123 by controlling the printing apparatus 11 (document printing processing); and, fifth, processing of transmitting the document that is stored in the second storage unit 123 to the external device via the external interface 125 (document transmission processing).

Each processing of the document management application as described above is executed by causing an operation instruction from a user received via the user interface 124 to be a trigger.

Furthermore, the platform unit 20, by executing the degraded document management application as an alternative application to be started as an alternative when the document management application is uninstalled, executes document reference processing, document printing processing and document transmission processing. That is, the degraded document management application has no function of document generation processing and document reception processing, and these processing are not executed. In addition, in document printing processing and document transmission processing of the degraded document management application, with respect to a document that is stored in the second storage unit 123, for example, either one processing is executed only once. In this case, the platform unit 20, after having executed either document printing processing or document transmission processing by execution of the degraded document management application, deletes this document having been stored in the second storage unit 123. With the arrangement, the degraded document management application, being an alternative application provides only a part of functions of the document management application.

In the below-described Embodiment 2 and Embodiment 3, descriptions will be made using these document management application and degraded document management application.

Further, the name to be stored in the data item 201 is “document management” in both cases of the document management application and the degraded document management application.

In addition, in the following descriptions, a document the document management application manages in the second storage unit 123 is referred to as a stored document.

Incidentally, since the degraded document management application has less functions as compared with those of the document management application, even if the platform unit 20 has started this degraded document management application, just a small area of the first storage unit 122 is occupied.

### (Description of Screen Display Example)

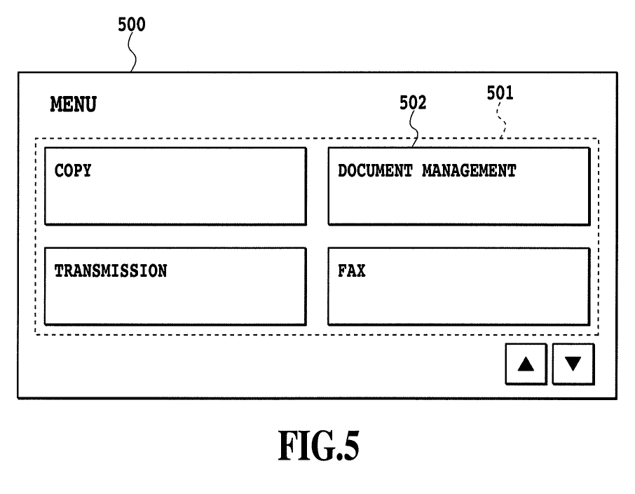

FIG. 5 is a diagram illustrating one example of a screen data to be displayed on a display (e.g., liquid crystal display) of the user interface 124.

A screen 500 is a menu screen for selecting an application.

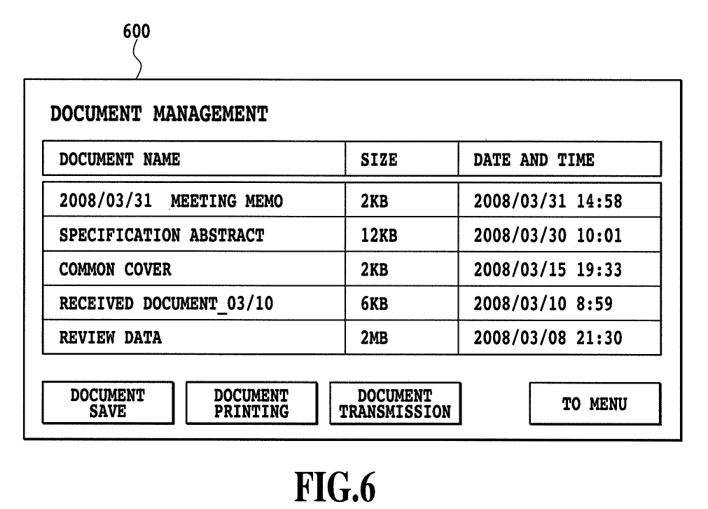

An application button group 501 indicates the application that is started by the platform unit 20. An application button 502 is an identification display indicating the above-described document management application. When the instruction of a user through the application button 502 is received, the CPU 121 performs a display control so that the screen of the document management application illustrated in FIG. 6 is displayed on the user interface 124. Detailed descriptions as to the screen illustrated in FIG. 6 will be omitted.

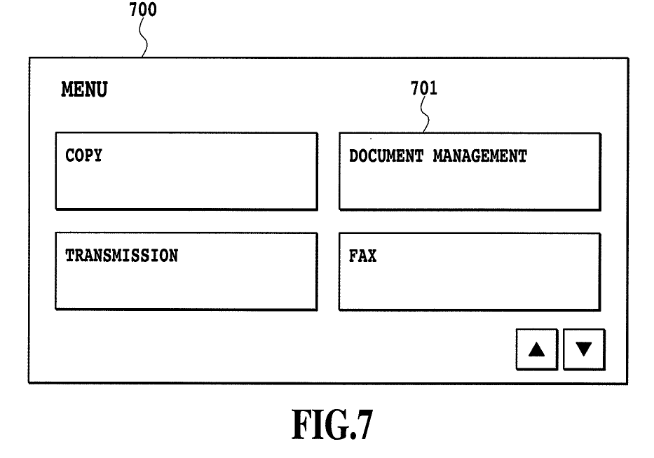

FIG. 7 is a diagram illustrating one example of a screen data to be displayed on a display of the user interface 124, and a screen 700 is a menu screen for selecting an application. The screen 700 is a menu screen to be displayed on the occasion when the platform unit 20 has uninstalled the document management application, and is the same display as the screen 500. As is obvious from comparison between FIG. 5 and FIG. 7, both screen arrangements are the same, and both display positions of application buttons (501, 701) on the screens are the same. The platform unit 20 is in the state in which the document management application has been uninstalled and the degraded document management application is started as an alternative.

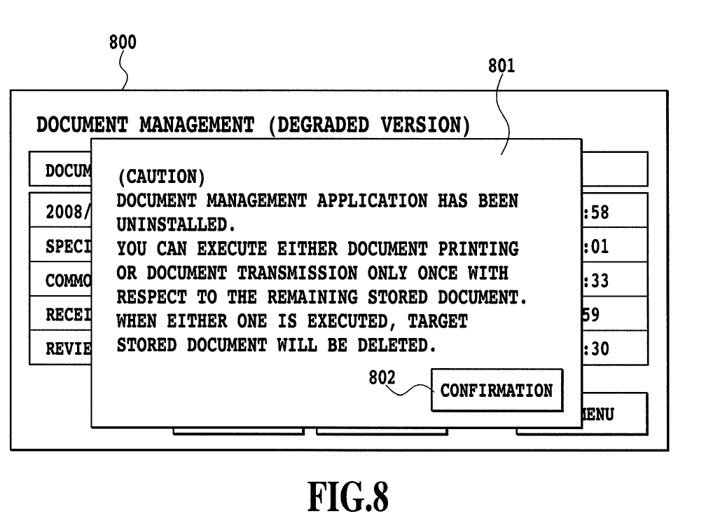

An application button 701 of FIG. 7 is an identification display indicating the degraded document management application. The CPU 121, when having received the instruction of a user through the application button 701, performs a display control so that the screen of the degraded document management application illustrated in FIG. 8 is displayed on the display of the user interface 124.

FIG. 8 is a diagram illustrating one example of a screen data to be displayed on the display of the user interface 124.

A screen 800 is a screen of the degraded document management application.

As is illustrated, on the screen 800, a label 801 is displayed with overlapped, and it is displayed that the document management application has been uninstalled and that either document printing processing or document transmission processing of the document that is stored in the second storage unit 123 can be executed only once.

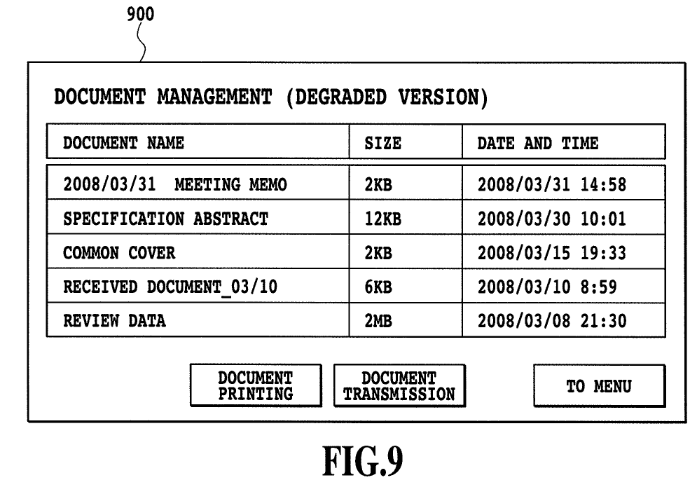

When the instruction of a user with a “confirmation” button 802 is received, a screen illustrated in FIG. 9 is displayed on the user interface 124.

FIG. 9 is a diagram of illustrating one example of a screen data to be displayed on the display of the user interface 124.

A screen 900 shows the degraded document management application. Although detailed descriptions of this screen will be omitted, with respect to the stored document having been under management of the document management application, only document printing processing or document transmission processing can be selected.

With the arrangement, according to this embodiment, an alternative application to be started as an alternative, when there is an uninstall instruction of this application, can preliminarily be associated to an application. Furthermore, when the application is actually uninstalled, the alternative application associated with this application can automatically be started. In addition, using this alternative application, minimum access means with respect to information (for example, a stored document) managed by the uninstalled application can be provided. Thus, it is possible to prevent situations in which a user cannot access the desired information at all after having deleted the application.

Furthermore, due to the fact that the application to be uninstalled and its alternative application are in the same screen arrangement, and that the positions of buttons with which the instruction of a user is received are linked and displayed in the same way, it is possible to prevent confusion in operation instructions of a user after the execution of uninstall.

### Embodiment 2

In Embodiment 1, a method is described in which, when installing both an application and its alternative application together, both of them have preliminarily been associated. In this embodiment, the method is described in which an application and its alternative application are installed individually, and thereafter both of them are associated. However, also in this embodiment, as in Embodiment 1, an application and its alternative application are associated before uninstalling this application.

Furthermore, in this embodiment, a method is described of attaching requirements to the startup of the alternative application and starting the alternative application more properly.

The alternative application is in a one-to-one correspondence relationship with the associated application. Therefore, at a time when there is no more information that has been created by a specified application and has been managed by this application, the alternative application associated with this application will be unnecessary. In this embodiment, a processing method is described of automatically uninstalling the alternative application on the condition that there is no more information having been under management of the uninstalled application.

In this embodiment, descriptions will be made using like reference numerals with the same arrangements and components as those of the above-described Embodiment 1. Furthermore, an install image file in this Embodiment will also be used in descriptions as the same one as that of Embodiment 1.

### (Description of Processing at the Time of Install)

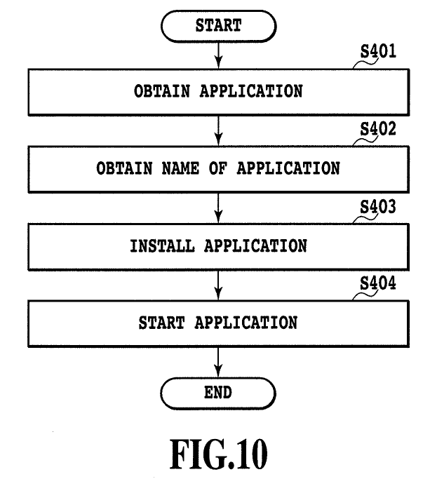

FIG. 10, in this embodiment, is a flowchart showing a processing procedure on the occasion when the platform unit 20 installs an application.

The external interface 125, when having received an install image file, informs the platform unit 20 of this reception. The platform unit 20 executes the following processing. Here, in the install image file, one application program and one its name are stored.

Since each processing shown in FIG. 10 is the same as the processing of S401 to S404 in FIG. 4, detailed descriptions thereof will be omitted.

A document management application, being an application to be uninstalled and a degraded document management application, being its alternative application are installed on the platform unit 20 in the procedure shown in FIG. 10, respectively.

### (Description of Associating Processing)

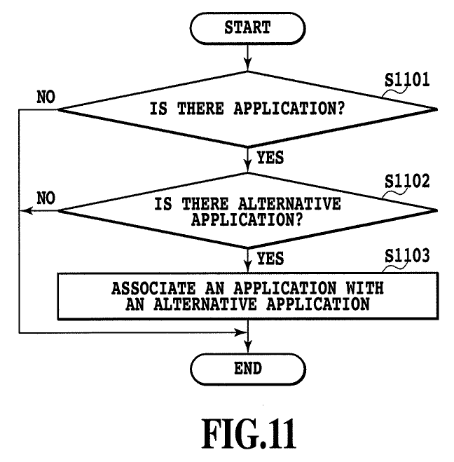

FIG. 11, in this embodiment, is a flowchart showing the procedure of associating an alternative application to be started as an alternative on the occasion when an application is uninstalled with this application that is executed by the platform unit 20.

The user interface 124, when having received the instruction of associating processing from a user, informs the platform unit 20 of this instruction. The platform unit 20 executes the following processing. At this time, the user interface 124 gives the ID of the application and the ID of the alternative application to be started as an alternative on the occasion when this application is uninstalled to the platform unit 20.

The platform unit 20 having received the above-described two IDs, first determines whether or not the application which ID corresponds to the former application ID is installed (S1101). This determination is made by searching and confirming the presence or absence of the record in which the name of the application which ID is coincident with the ID of the former application is stored in the data item 201 from each record of the application management data 200. In the case in which the application which ID corresponds to this ID is determined to be installed, processing goes to S1102.

In S1102, the platform unit 20 determines whether or not the application which ID corresponds to the ID of the latter alternative application is installed. This determination is made by searching and confirming the presence or absence of the record in which the name of the application which ID is coincident with the ID of the alternative application is stored in the data item 201 from each record of the application management data 200. In the case in which the alternative application which ID corresponds to this ID is determined to be installed, processing goes to S1103.

Further, in S1103, the platform unit 20 stores the ID of the alternative application in the data item 204 of the record of the former application. Thus, the application and the alternative application to be started as an alternative on the occasion when this application is uninstalled are associated.

On the other hand, in each processing of S1101, S1102, when the applications having IDs that correspond to these IDs are determined not to be installed, respectively, processing is immediately ended.

### (Description of Processing at the Time of Uninstall)

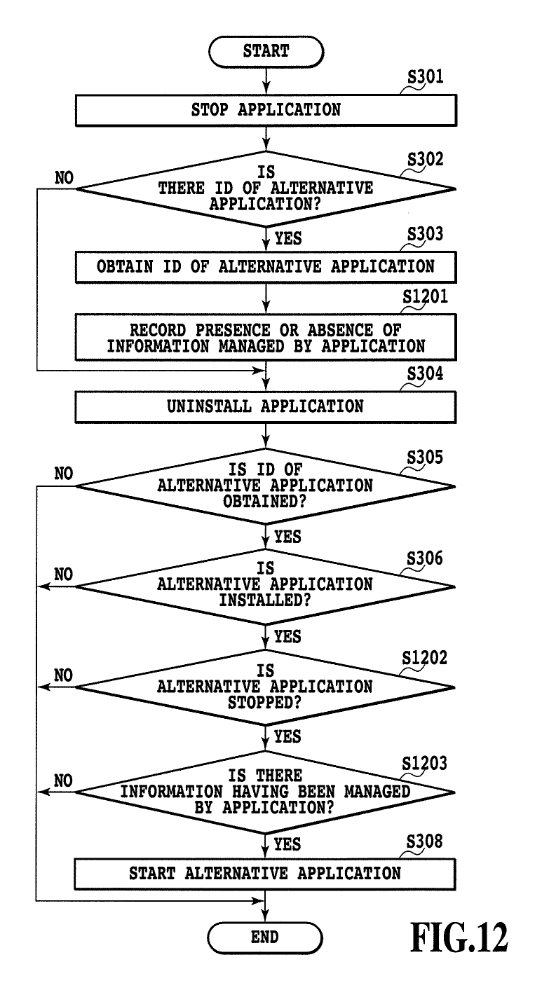

FIG. 12, in this embodiment, is a flowchart showing a processing procedure on the occasion when the platform unit 20 uninstalls an application.

The user interface 124, when having received an uninstall instruction of an application from a user, informs the platform unit 20 of this instruction. The platform unit 20 then executes the following processing.

Since each processing of S301 to S306, and S308 in FIG. 12 is the same as the processing described in FIG. 3, detailed descriptions will be omitted.

In the flowchart of FIG. 12, when the processing up to S303 is ended, the platform unit 20 confirms whether information managed by the application of the uninstall target is present or absent, and stores results thereof in the first storage unit 122 (S1201). This confirmation, for example, in the case of a document management application, is processing of confirming whether or not one or more stored documents that are created by the document management application are stored in an area managed by the document management application in the second storage unit 123. Thus, contents to be confirmed by this processing are varied depending on the application. Therefore, this confirmation is desirably done by the platform unit 20 by executing this application.

When the processing of S1201 is ended, processing of S304 to S306 is executed. In the processing of S306, when the alternative application is determined to be installed, processing goes to the processing of S1202. In the processing of S1201, the platform unit 20 confirms whether or not the alternative application is stopped. Although this processing itself is the same as the processing described in S307, it differs from the flow of FIG. 3 according to Embodiment 1 at the point of proceeding further to determination processing of S1203 when the alternative application is determined to be stopped. The reason for adding such determination processing is to consider the case in which there is no more present information that is created by the application to be uninstalled and stored in its management area at the time of uninstall. In this case, the alternative application does not need to be started. By the execution of this determination processing, the alternative application can be started only in the case of being really required.

When the alternative application is determined not to be stopped in the processing of S1202, processing is ended.

In the processing of S1203, the platform unit 20 determines whether information (data created by a user such as a stored document created using this application) that has been managed by the application having been uninstalled in S304 is present or absent in the second storage unit 123. This determination is made based on confirmation processing results of S1201 (information the platform unit 20 has stored in the first storage unit 122). Here, in the case in which information having been managed by the uninstalled application is determined to be present, processing goes to S308, in which the alternative application is started. However, in case where information having been managed by the uninstalled application is determined to be absent, processing is ended. (Description of uninstall of alternative application)

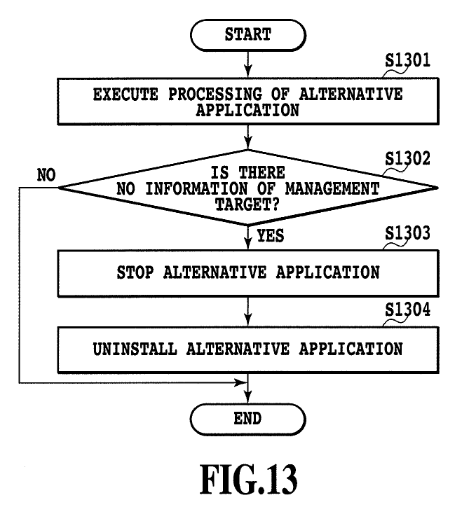

FIG. 13, in this embodiment, is a flowchart showing a processing procedure on the occasion when the platform unit 20 executes an alternative application to be started as an alternative.

The user interface 124, when having received an operation instruction of the alternative application from a user, informs the platform unit 20 of this instruction. The platform unit 20 then executes the following processing.

First, the platform unit 20 performs the processing of the alternative application in response to the operation instruction from a user (S1301). Although the processing content to be executed on this occasion depends on the kind of the alternative application, for example, in the case of the above-mentioned degraded document management application, it is either document printing processing or document transmission processing.

Next, the platform unit 20 determines whether the information having been managed by the uninstalled application is present or absent (S1302). Although this determination also depends on the application having been uninstalled, in the case of the above-mentioned document management application, it is determined whether or not the stored document having been created by this document management application is present or absent in the area managed by this document management application in the second storage unit 123. When the information managed by the application of the uninstall target is determined to be absent, processing goes to S1303.

In the processing of S1303, the platform unit 20 stops the alternative application that is unnecessary.

Subsequent to the stop processing of the alternative application, the platform unit 20 uninstalls the alternative application (S1304).

In the determination processing of S1302, when the information managed by the uninstalled application is determined to be present, this processing is immediately ended.

With the arrangement according to this embodiment, an application of the uninstall target and an alternative application on the occasion when this application is uninstalled can be installed individually, and thereafter can preliminarily be associated by the instruction of a user.

Furthermore, since it is a condition for starting the alternative application that the presence or absence of the information managed by the uninstalled application is confirmed, and that this information is present, the unnecessary startup of the alternative application can be prevented.

In addition, when there is no more information managed by the uninstalled application, the alternative application that is now unnecessary can automatically be uninstalled.

### Embodiment 3

In Embodiment 1 or Embodiment 2, an alternative application needs to be installed on the second storage unit 123 of the platform unit 20 before an application of the uninstall target is actually uninstalled. In this embodiment, the method is described in which, when an application of the uninstall target is uninstalled, an alternative application to be started as an alternative is obtained from an external device and installed.

Also in this embodiment, descriptions will be made using like reference numerals with the same arrangements and components as those of the above-mentioned Embodiment 1 and Embodiment 2.

### (Description of Install Image File)

In this embodiment, the external interface 125 receives an install image file of the below-described form.

An install image file in this embodiment is a file in which an application program of the install target and its name are stored. Furthermore, the install image file according to this embodiment can include location information (for example, URL (Uniform Resource Locator)) of the alternative application. This location information is the information of indicating the place of the install image file of the alternative application that is stored in the external device.

### (Description of Processing at the Time of Install)

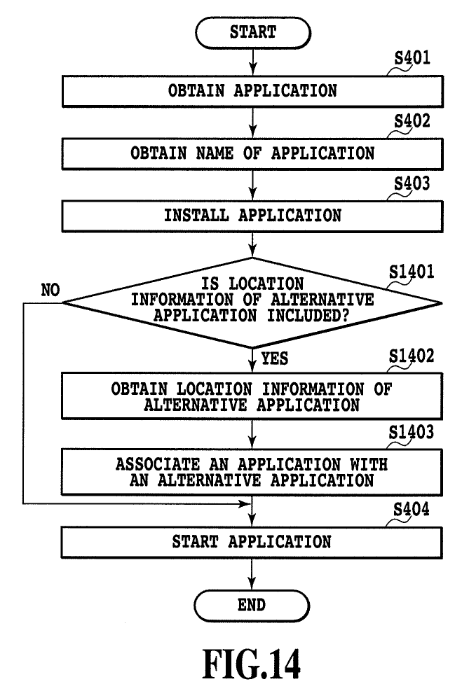

FIG. 14, in this embodiment, is a flowchart showing a processing procedure on the occasion when the platform unit 20 installs an application.

The external interface 125, when having received the install image file, informs the platform unit 20 of this reception. The platform unit 20 then executes the following processing.

Since each processing of S401 to S404 in FIG. 14 is the same as the processing described in FIG. 4, detailed descriptions will be omitted.

The platform unit 20, when having installed the application in S403, determines whether or not the location information of the alternative application is stored in the install image file in which this installed application is stored (S1401). In the case in which the location information is determined to be included, processing goes to S1402. In the case in which the location information is determined not to be included, processing goes to S404, in which the application is started.

In S1402, the platform unit 20 obtains the location information of the alternative application from the install image file.

In the subsequent processing of S1403, the platform unit 20 stores the location information of the alternative application in the data item 204 of the record corresponding to the application having been installed (S403).

### (Description of Processing at the Time of Uninstall)

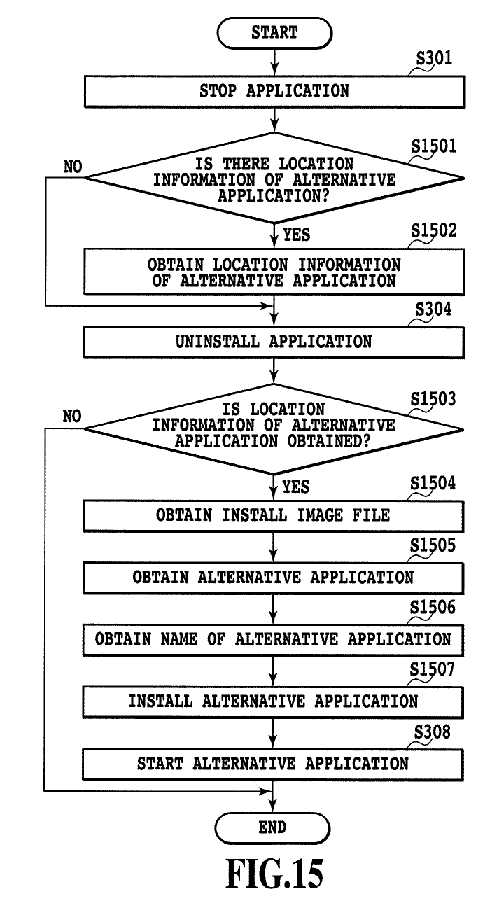

FIG. 15 is a flowchart showing a processing procedure on the occasion when the platform unit 20 uninstalls the application.

The user interface 124, when having received the uninstall instruction of the application from a user, informs the platform unit 20 of this instruction. The platform unit 20 then executes the following processing.

Since each processing of S301, S304 and S308 in FIG. 15 is the same as the processing illustrated in FIG. 3, detailed descriptions will be omitted.

First, the platform unit 20 stops the target application instructed to be uninstalled (S301). Next, the platform unit 20 determines whether or not an alternative application is set with respect to the target application instructed to be uninstalled (S1501). This determination is made by referring to the application management data 200. That is, it is made by confirming whether or not the location information data of the alternative application is stored in the data item 204 of the record of the target application instructed to be uninstalled. In the case in which the alternative application is determined to be set, processing goes to S1502. When the alternative application is determined not to be set, processing goes to S304.

In S1502, the platform unit 20 obtains the location information of the alternative application associated with the target application instructed to be uninstalled, and stores this location information in the first storage unit 122 in addition to the application management data 200. This location information can be obtained by reading out data that is stored in the data item 204 of the record of the target application instructed to be uninstalled in the application management data 200. The platform unit 20, when having obtained the location information, uninstalls the target application instructed to be uninstalled (S304).

When the uninstall processing of the application is ended, the platform unit 20 determines whether or not the location information of the alternative application is obtained (S1503). This determination is made by determining whether or not the platform unit 20 stores the location information of the alternative application in the first storage unit 122 in addition to the application management data 200. When the location information of the alternative application is determined to be obtained, the operation goes to S1504. On the other hand, when the location information of the alternative application is determined not to be obtained, the processing is immediately ended.

In S1504, the platform unit 20 obtains the install image file of the alternative application from the location that is indicated by the location information of the alternative application via the external interface 125.

Further, the platform unit 20 obtains the alternative application program from the install image file having been obtained (S1505).

Next, the platform unit 20 obtains the name of the alternative application from the install image file having been obtained (S1506).

The platform unit 20, when having obtained the alternative application program and its name, installs the alternative application program on the second storage unit 123 (S1507). At this time, the platform unit 20 adds the record to the application management data 200, and thus the name of the alternative application is stored in the data item 201 of the added record.

Further, the platform unit 20 starts the alternative application instead of the application having been uninstalled (S308).

With the arrangement according to this embodiment, at the time of uninstalling the application, the alternative application is obtained from the external device based on associating setting having previously been executed. Furthermore, this alternative application is installed, and after the associated application has been uninstalled, the alternative application can be started. During the time the application is being used, the second storage unit 123 can effectively be utilized.

### Other Embodiments

A processing method of storing, in a computer readable recording medium, a program for implementing functions of the above-described embodiments, and reading the program that is stored in this recording medium as a code and executing it in a computer will also fall within the scope of the above-described embodiments. Furthermore, the recording medium in which the above-described program is stored, and additionally this program itself are also included in the above-described embodiments.

For example, such recording medium can be a floppy (trademark) disk, a hard disk, an optical disk, a magnetic optical disk, CD-ROM, a magnetic tape, a non-volatile memory card and a ROM.

Furthermore, not only the one to execute processing based on the program that is stored in the above-described recording medium alone, but also the one to operate on an OS and to execute operations of the above-described embodiments in cooperation with other software or the function of an expanded board will also fall within the scope of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-134546, filed May 22, 2008, which is hereby incorporated by reference herein in its entirety.

What is claimed is:

1. An application platform comprising:
an uninstall component configured to uninstall an application when a user interface receives an instruction to uninstall the application from a user;
a starting component configured to start an alternative application associated with an application when the application is uninstalled by the uninstall component; and
an associating component configured to associate the alternative application with the application before the user interface receives an instruction to uninstall the application from a user.

2. An application platform according to claim 1 further comprising:
an install component configured to install an application,
wherein association of the alternative application with the application by the associating component is executed at the time of installing the application executed by the install component.

3. An application platform according to claim 1, wherein the alternative application is an application for managing information managed by an application that is associated with the alternative application by the associating component.

4. An application platform according to claim 3 further comprising:
a storage unit configured to store information; and
a determination component configured to determine whether information managed by an application to be uninstalled by the uninstall component is present or absent in the storage unit even after the application has been uninstalled by the uninstall component,
wherein the starting component causes the alternative application to start when the information is determined to be present by the determination component, and causes the alternative application not to start when the information is determined to be absent by the determination component.

5. An application platform according to claim 3, wherein when there is no more information managed by an application that has been uninstalled by the uninstall component in the storage unit, the alternative application is uninstalled.

6. An application platform according to claim 3 further comprising:
a display control component configured to control a display to display a menu screen for selecting an application;
wherein the display control component controls the display so that an identification display in the case of selecting the alternative application is displayed on a menu screen on which an identification display of an application that is associated with the alternative application has been displayed before being uninstalled.

7. An application platform according to claim 6, wherein when an identification display in the case of selecting the alternative application is displayed by the display control component on a menu screen on which an identification display of an application that is associated with the alternative application has been displayed before being uninstalled,
a display position of an identification display in the case of selecting the alternative application is the same as a display position in which an identification display of an application that is associated with the alternative application has been displayed before being uninstalled.

8. An application platform according to claim 1,
wherein when the alternative application is not installed when an application is uninstalled by the uninstall component, the alternative application is obtained from an external device.

9. An application management method, the method comprising the steps of:
uninstalling an application when a user interface receives an instruction to uninstall the application from a user;
starting an alternative application that is associated with an application when the application is uninstalled in the uninstalling step; and
associating the alternative application with the application before the user interface receives an instruction to uninstall the application from a user.

10. An application management method according to claim 9 further comprising the step of:
installing an application;
wherein association of the alternative application with the application by the associating step is executed at the time of install of the application in the installing step.

11. An application management method according to claim 9, wherein the alternative application is an application for managing information managed by an application that is associated with the alternative application in the associating step.

12. An application management method according to claim 11 further comprising the steps of:
storing information; and
determining whether or not information managed by an application to be uninstalled in the uninstall step is stored even after the application has been uninstalled in the uninstalling step;
wherein the starting step causes the alternative application to start when the information is determined to be present in the determination step, and causes the alternative application not to start when the information is determined to be absent in the determination step.

13. An application management method according to claim 11, wherein when there is no more information managed by an application that has been uninstalled in the uninstalling step in a storage unit, the alternative application is uninstalled.

14. An application management method according to claim 11 further comprising the step of:
Controlling a display so as to display a menu screen for selecting an application;
wherein the display control step controls so that an identification display in the case of selecting the alternative application is displayed on a menu screen on which an identification display of an application that is associated with the alternative application has been displayed before being uninstalled.

15. An application management method according to claim 14, wherein when an identification display in the case of selecting the alternative application in the display control step is displayed on a menu screen on which an identification display of an application that is associated with the alternative application has been displayed before being uninstalled,
a display position of an identification display in the case of selecting the alternative application is the same as a display position in which an identification display of an application that is associated with the alternative application has been displayed before being uninstalled.

16. An application management method according to claim 9, wherein when the alternative application is not installed when an application is uninstalled in the uninstalling step, the alternative application is obtained from an external device.

17. A program provided on a computer readable medium for performing an application management method, the method comprising the steps of:
uninstalling an application when a user interface receives an instruction to uninstall an application from a user;
starting an alternative application that is associated with the application when the application is uninstalled in the uninstalling step; and
associating the alternative application with the application before the user interface receives the instruction of uninstall of the application from a user.
